(19) United States
(12) Patent Application Publication
(10) Pub. No.: US 2006/0202159 A1
(43) Pub. Date: Sep. 14, 2006

(54) Oxidizing agent for chemical mechanical polishing slurry composition

(75) Inventors: Jong-Dai Park, Hwaseong-Si (KR); Dong-Wan Kim, Hwaseong-Si (KR)

Correspondence Address: BIRCH STEWART KOLASCH & BIRCH, PO BOX 747, FALLS CHURCH, VA, 22040-0747, US

(73) Assignee: DONGJIN SEMICHEM CO., LTD.

(21) Appl. No.: 11/317,076

(22) Filed: Dec. 27, 2005

(30) Foreign Application Priority Data
Mar. 14, 2005 (KR) 10-2005-0021083

(51) Int. Cl. C11D 3/39

(52) U.S. Cl. 252/186.1

(57) ABSTRACT

Disclosed are an oxidizing agent useful for preparing a chemical mechanical polishing (CMP) slurry composition and a method for producing the same. The method for preparing an oxidizing agent for a CMP slurry composition comprises the steps of: preparing an aqueous iron salt solution by admixing an iron salt and cooled water of 5° C. or less; and preparing a nano synthesis particle by admixing and stirring a silica salt and the aqueous iron salt solution for carrying out a reaction of the silica salt, wherein the nano synthesis particle is a colloidal silica containing iron.

### FIELD OF THE INVENTION

This invention relates to an oxidizing agent, and more specifically, to an oxidizing agent useful for preparing a chemical mechanical polishing (CMP) slurry composition and a method for producing the same. The oxidizing agent effectively converts a metal layer into a metal oxide layer, and also effectively polishes the metal oxide layer in a semiconductor manufacturing process.

### BACKGROUNDS OF THE INVENTION

An integrated semiconductor chip includes a large number of electrical elements, such as transistors, capacitors, resistors and so on, and the electrical elements are connected with conductive metal layers of a certain pattern to form functional circuits. The size of the integrated semiconductor chip becomes smaller and the functionality thereof becomes being magnified over several generations. To increase the integration degree of the semiconductor chip, the size of the electrical elements may be reduced. However, there is an inherent limitation in reducing the size of the electrical elements. Thus, a multilevel interconnection technology of the electrical elements has been actively studied and developed. In manufacturing a semiconductor device with the multilevel interconnection technology, a planarization process of a metal layer is indispensable. The metal layer is not easily polished due to its relatively high strength, and therefore, the metal layer should be converted into a metal oxide layer having a relatively low strength for effective polishing of the metal layer.

CMP slurry compositions for such polishing of a metal layer were disclosed in Korean Unexamined Publication Nos. 2004-29239, 2004-35073, 2004-35074 and 2004-55042. However, the CMP slurry compositions disclosed in the above-mentioned references have a disadvantage of not providing sufficient chemical conversion of the metal layer into the metal oxide layer. From 1876, Fenton's reagent, which is a composition composed with hydrogen peroxide and iron salt, is conventionally used for oxidizing a metal layer. However, in the method, an excess amount of iron salt, such as Fe(NO₃)₃ is necessary, and the excess iron salt may badly influence the metal layer to be polished. Accordingly, it is necessary to develop an oxidizing agent which effectively oxidizes the metal layer and does not produce defects on the polished metal layer.

### SUMMARY OF THE INVENTION

Therefore, it is an object of the present invention to provide an oxidizing agent which is useful for preparing a chemical mechanical polishing (CMP) slurry composition and a method for producing the same. It is other object of the present invention to provide an oxidizing agent which is capable of effectively and uniformly oxidizing a metal layer to be polished and a method for producing the same. It is another object of the present invention to provide an oxidizing agent which is capable of reducing defects on the polished metal layer, which are generated by a metal salt such as an iron salt in the CMP slurry composition.

To achieve these and other objects, the present invention provides a method for preparing an oxidizing agent for a CMP slurry composition. The method includes the steps of: preparing an aqueous iron salt solution by admixing an iron salt and cooled water of 5° C. or less; and preparing a nano synthesis particle by admixing and stirring a silica salt and the aqueous iron salt solution for carrying out a reaction of the silica salt, wherein the nano synthesis particle is a colloidal silica containing iron. The present invention also provides an aqueous oxidizing agent solution comprising: a nano synthesis particle which is a colloidal silica containing iron, wherein the amount of the nano synthesis particle is 0.1 to 20 weight % with respect to the total aqueous oxidizing agent solution; and water.

### BRIEF DESCRIPTION OF THE DRAWINGS

FIG. 1 is a transmission electron microscope photograph obtained after drying the CMP slurry composition including the nano synthesis particle of the present invention.

FIGS. 2a-2d are Energy Dispersive X-ray spectrometer measurement graphs measured at each local area depicted in the photograph of FIG. 1.

FIG. 3 is a photograph showing the colorimetry test results for detecting Fe²⁺ ion component in CMP slurry compositions.

FIG. 4 is an Electron paramagnetic resonance measurement results for detecting Fe³⁺ ion component in CMP slurry compositions.

### DETAILED DESCRIPTION OF THE INVENTION

A more complete appreciation of the invention, and many of the attendant advantages thereof, will be better appreciated by reference to the following detailed description.

The oxidizing agent of the present invention is useful for preparing a CMP slurry composition. In order to prepare the oxidizing agent of the present invention, first, an aqueous iron salt solution is prepared by admixing an iron salt and cooled water of 5° C. or less. The preferable water for this step is water from which impurities, such as metal ion, are completely removed, and the more preferable water is deionized water. The temperature of water is 5° C. or less, preferably 3° C. or less, and more preferably 0 to 5° C. If the temperature of the water is more than 5° C., the size of the produced colloidal particle may become undesirably larger due to the exothermic hydration reaction. The representative example of the iron salt useful for the present invention is FeCl₃. The concentration of the iron salt in the aqueous iron salt solution is 0.1 to 99.0 mol %, preferably 0.1 to 50.0 mol %, and more preferably 0.1 to 20.0 mol % with respect to the total aqueous iron salt solution. If the concentration of the iron salt is less than 0.1 mol %, the amount of the iron in the final oxidizing agent becomes too small, and the oxidizing agent may not effectively oxidize a metal layer. If the concentration of the iron salt is more than 99.0 mol %, all of the iron may not be contained in the colloidal silica.

Then, a silica salt is, for example slowly and dropwisely, added to the produced aqueous iron salt solution, and stirred for carrying out a reaction of the silica salt to produce a nano synthesis particle (NSP). The nano synthesis particle (NSP) is a colloidal silica containing iron (Fe/Si). As the silica salt, various compound, which can be separated into silica ion in water, can be used for the purpose of this invention. The representative example of the silica salt is SiCl₄. The amount of the silica salt is preferably controlled so that the amount of Si contained in the silica salt is 2 to 10 times of the amount of Fe contained in the iron salt by the mole ratio. If the amount of Si is less than 2 times of that of Fe by mole ratio, the produced colloidal silica cannot accommodate all Fe, and the excess Fe, which is in the ion state, is remained in the CMP slurry composition. In this case, defects can be formed on the polished metal layer due to the Fe ion. On the contrary, if amount of Si is more than 10 times of that of Fe by mole ratio, the amount of Fe in the colloidal silica is too little, and therefore the desirable abrasion and oxidization of the metal layer cannot be performed. The temperature of the silica salt, which is added to the aqueous iron salt solution, is preferably 10° C. or less, and preferably −20° C. or less. The hydration reaction of the silica salt can be carried out at 5° C. or less, preferably 3° C. or less, and more preferably carried out at 1° C. or less. If the temperature of the silica salt, which is added to the aqueous iron salt solution, is more than −10° C., vaporization of the silica salt may occur. If the temperature of the hydration reaction is more than 5° C., the size of the produced colloidal particle may become undesirably larger due to the exothermic hydration reaction. The iron salt and silica salt can be used without any pre-treatment.

After adding the silica salt to the aqueous iron salt solution, it is preferable to remove anions, such as Cl⁻, contained in the hydration reaction solution so as to prevent the rapid growth of the final colloidal particles. If the ions, such as Cl⁻, are removed from the hydration reaction solution, the ionic strength of the solution is reduced, and the solution is stabilized. As the representative method for removing ions from the hydration reaction solution, a method of dialyzing the hydration reaction solution with a membrane at room temperature can be used. The dialysis can be carried out until the pH of the solution is less than a predetermined level, for example, until the pH of the solution is less than 3. Exemplary membrane for the dialysis is a membrane having MWCO (Molecular Weight of Cut-Off) of 6000 to 8000.

In the prepared oxidizing agent solution, the iron (Fe) bonds to the silica in the colloidal silica particle, and is not in the ion state. In the nano synthesis particle (NSP) oxidizing agent solution, the size of the nano synthesis particle (NSP) can be varied according to the CMP process conditions, and is preferably 50 to 150 nm and more preferably 50 to 100 nm. If the size of the NSP is less than above-mentioned range, the polishing efficiency can be lowered, and if the size of the NSP is more than above-mentioned range, scratches can be formed on the surface of the substrate to be polished. The amount of the NSP in the aqueous oxidizing agent solution of the present invention can be varied according to the CMP process conditions, oxidizing agent manufacturing conditions, and delivery conditions of the CMP slurry components. The preferable amount of the NSP in the aqueous oxidizing agent solution is 0.1 to 20 weight % with respect to the total aqueous oxidizing agent solution. The NSP solution works as an oxidizing agent for oxidizing the metal layer, and also works as the abrasive in a CMP process.

The NSP oxidizing agent solution produced according to the present invention is preferably stored at the low temperature of 4° C., and admixed with other components of CMP slurry composition just before carrying out the polishing of a metal layer. Alternatively, the NSP oxidizing agent solution can be pre-mixed with other components of CMP slurry composition, and stored and delivered at low temperature for the future polishing process. When a CMP slurry composition is produced with the NSP oxidizing agent, the amount of the NSP oxidizing agent in the CMP slurry composition is preferably 0.0001 to 5.0 weight %, more preferably 0.0001 to 3.0 weight %, and most preferably 0.0001 to 0.5 weight % with respect to the total CMP slurry composition. If the amount of the NSP oxidizing agent is less than 0.0001 weight %, it is difficult to obtain a synergic effect of the polishing and oxidation of the NSP oxidizing agent, and if the amount of the NSP oxidizing agent is more than 5.0 weight %, the oxidation force thereof is so big that a polishing defect such as a erosion of the metal layer can be occurred. The CMP slurry composition including the NSP oxidizing agent includes no or a very little ionized iron salts in the CMP slurry composition. Therefore, the defects possibly generated during the polishing process of the metal layer can be minimized, and process stability and manufacturing yield of the CMP process are excellent.

Hereinafter, preferable example is provided for better understanding of the present invention. However, the present invention is not limited to the following example.

### EXAMPLE

### Preparation of NSP Oxidizing Agent

Deionized water was cooled to 1° C., and FeCl₃ was added into the deionized water with active stirring so that the concentration of FeCl₃ became 20 mol %. To the solution, SiCl₄, which was kept at −20° C. or less, was slowly and dropwisely added and stirred to prepare a colloidal solution. The amount of SiCl₄ was controlled so that the amount of Si in the SiCl₄ is 4 times of the amount of Fe in the FeCl₃ by the mole ratio. Cl ion contained in the colloidal solution was dialyzed with Spectra/Por membrane (MWCO: 6000-8000) at room temperature in order to prevent the rapid growth of particles in the final colloidal solution and to stabilize the particles, which results in the decrease of the ionic strength of the solution. The dialysis was carried out until the pH of the solution became less than 3. The obtained NSP oxidizing agent solution was kept at the temperature of 4° C.

### TEST EXAMPLE 1

### Iron Component Distribution Analysis Using EDX

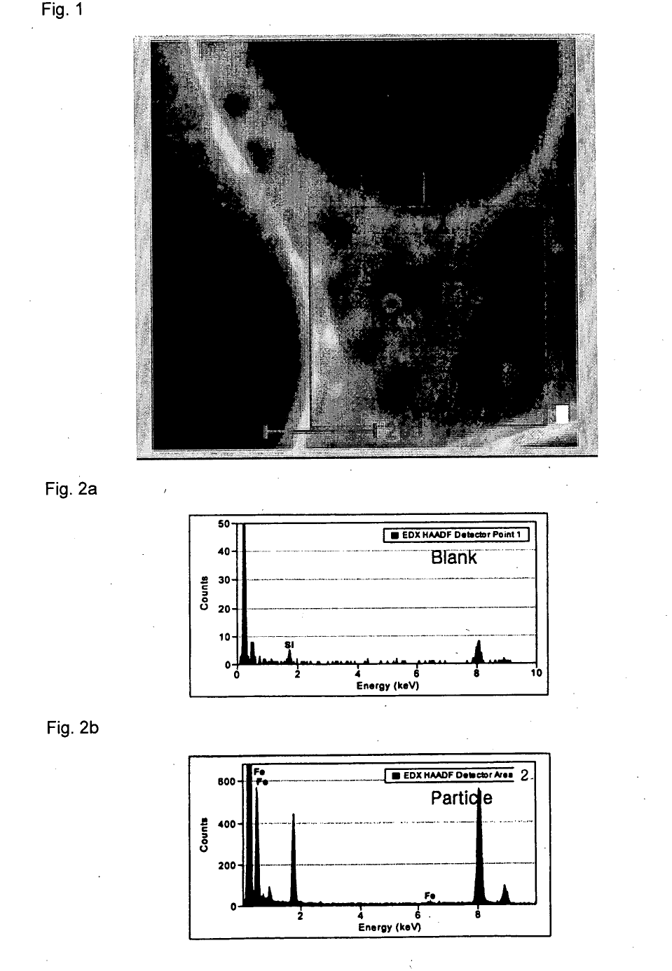

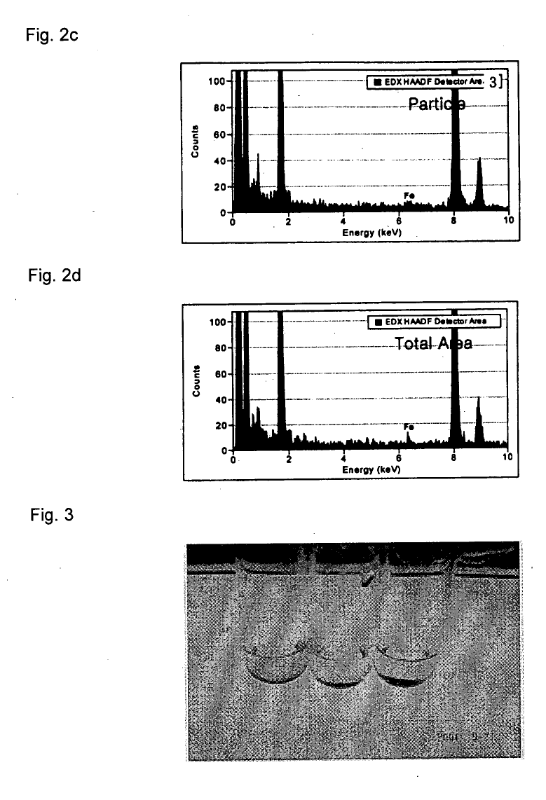

A CMP slurry composition including 0.2 weight % of NSP oxidizing agent obtained from the above Example, 6.0 weight % of fumed silica as an abrasive, and water as the remainder was prepared. The CMP slurry composition was coated on a grid. After drying the CMP slurry composition, high angle annular dark-field (HAADF) transmission electron microscope (TEM) photograph was obtained (FIG. 1). Each local area depicted in the photograph of FIG. 1 was measured with an Energy Dispersive X-ray spectrometer (EDX), and the measured results are depicted in FIGS. 2a to 2d. As shown in FIG. 2a, a little colloidal silica (Si) component is detected, and iron (Fe) component is not detected in the blank area which does not include the NSP oxidizing agent. Therefore, it is confirmed that the iron (Fe) component does not exist outside of the NSP oxidizing agent. From the EDX result (FIG. 2d) of the total area including the blank area and NSP oxidizing agent area, the EDX result (FIG. 2b) of the abrasive area, and the EDX result (FIG. 2c) of the NSP oxidizing agent area, it is also confirmed that the iron (Fe) component of the ion state does not exist in the CMP slurry composition. In the EDX results shown in FIGS. 2b, 2c and 2d the ratios of Fe and Si are constant, which means that all of the iron (Fe) component exists in the NSP oxidizing agent.

### TEST EXAMPLE 2

### Iron Component Distribution Analysis Using Colorimetry

A CMP slurry composition including 0.2 weight % of the NSP oxidizing agent obtained from the above Example, 6.0 weight % of fumed silica as an abrasive, and water as the remainder was prepared. A slurry composition including Fe(NO₃)₃ instead of the NSP oxidizing agent was also prepared. HCl/ferrozine indicator solution was added to each of the two slurry compositions and water (a blank solution) to detect Fe²⁺ ion component, and the color of the samples were observed. The results are depicted in FIG. 3. As shown in FIG. 3, a color change is not detected from the slurry including the NSP oxidizing agent (left test tube in FIG. 3) and the pure water (right test tube in FIG. 3), which means that the Fe²⁺ ion component does not exist in the solutions. On the contrary, a color change is detected from the slurry including Fe(NO₃)₃ and water (center test tube in FIG. 3), which means that the Fe²⁺ ion component exists in the solution.

### TEST EXAMPLE 3

### Iron Component Distribution Analysis Using EPR (Electron Paramagnetic Resonance)

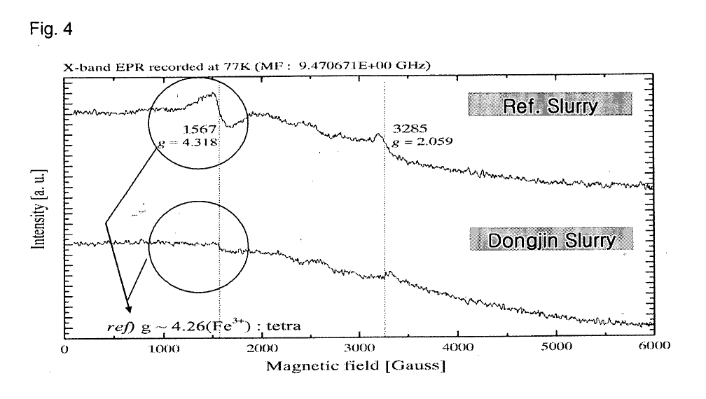

A CMP slurry composition including 0.2 weight % of NSP oxidizing agent obtained from the above Example, 6.0 weight % of fumed silica as an abrasive, and water as the remainder was prepared. A slurry composition (reference slurry) including Fe(NO₃)₃ instead of the NSP oxidizing agent was also prepared. EPR (Electron paramagnetic resonance) measurement was carried out for each of the two slurry compositions, and the results are depicted in FIG. 4. As shown in FIG. 4, the graph of the reference slurry (upper graph in FIG. 4) has a peak representing Fe³⁺ derived from Fe(NO₃)₃, and the graph of the slurry including the NSP oxidizing agent (lower graph in FIG. 4) does not have a peak representing Fe³⁺.

### EXPERIMENTAL EXAMPLES 14 AND COMPARATIVE EXAMPLE 1

### Polishing Rate Test of CMP Slurry Composition According to Amount of NSP Oxidizing Agent

CMP slurry compositions including 6.0 weight % of fumed silica, 2.0 weight % of hydrogen peroxide, the NSP oxidizing agent produced in Example and of the amount shown in Table 1, 0.06 weight % of malonic acid, 0.01 weight % of formaldehyde-naphthalenesulfonic acid polymer sodium salt as a dispersion stabilizer and water as the remainder were prepared (Examples 14). In addition, a comparative CMP slurry composition including 5.0 weight % of fumed silica, 2.0 weight % of hydrogen peroxide, 0.006 weight % of Fe ion (added in the form of Fe(NO₃)₃), 0.06 weight % of malonic acid, 0.001 weight % of formaldehyde-naphthalenesulfonic acid polymer sodium salt and water as the remainder was prepared (Comparative example 1). The pH of the CMP slurry compositions were controlled with nitric acid or ammonia as shown in Table 1. The blanket wafer having tungsten metal layer and the blanket wafer having silicon oxide layer were separately polished with the CMP slurry compositions, and the removal rate thereof were measured and are set forth in Table 1. The polishing were carried out with a polishing equipment “POLI-500CE” manufactured by G&P technology Inc., STT™ W711 pad and NF-200 carrier film manufactured by Thomas West Inc. The polishing conditions were as follows: 50 rpm of platen speed, 50 rpm of head speed, 5 psi of down pressure, 150 ml/min of slurry supplying rate and 1 minute of polishing time.

TABLE 1

| | Amount | Amount | | Removal Rate of | Removal Rate | |
|---|---|---|---|---|---|---|
| | of NSP | of total | | tungsten metal | of silicon oxide | |
| | (ppm) | Fe (ppm) | pH | layer (Å/min) | layer (Å/min) | Selectivity |
| Comparative | 0 | 60 | 2.3 | 2100 | 22 | 95 |
| example 1 | | | | | | |
| Example 1 | 10 | 0.03 | 2.8 | 1110 | 21 | 53 |
| Example 2 | 100 | 0.3 | 2.7 | 1550 | 23 | 67 |
| Example 3 | 600 | 2 | 2.6 | 1720 | 22 | 78 |
| Example 4 | 3000 | 9 | 2.5 | 2080 | 21 | 99 |

As shown in Table 1, as the amount of the NSP oxidizing agent increases, the removal rate of the tungsten metal layer and the selectivity increase. Also, the CMP slurry composition of the present invention has a removal rate of the tungsten metal layer and selectivity similar to the CMP slurry composition including ionized iron. Therefore, the CMP slurry composition of the present invention has a superior polishing efficiency with little iron ion, and therefore the defects on the polished metal layer can be reduced.

As described above, the NSP oxidizing agent is useful for preparing a CMP slurry composition for polishing a metal layer selected from the group consisting of a tungsten containing metal layer, titanium containing metal layer, and titanium nitride containing metal layer. The NSP oxidizing agent is capable of effectively converting the metal layer to be polished into the metal oxide layer, and is capable of reducing the polishing defects. While the present invention has been described in detail with reference to the preferred embodiments, those skilled in the art will appreciate that various modifications and substitutions can be made thereto without departing from the spirit and scope of the present invention as set forth in the appended claims.

1. A method for preparing an oxidizing agent for a chemical mechanical polishing slurry composition, comprising the steps of:
preparing an aqueous iron salt solution by admixing an iron salt and cooled water of 5° C. or less; and
preparing a nano synthesis particle by admixing and stirring a silica salt and the aqueous iron salt solution for carrying out a reaction of the silica salt, wherein the nano synthesis particle is a colloidal silica containing iron.

2. The method for preparing an oxidizing agent for a chemical mechanical polishing slurry composition of claim 1, wherein the iron salt is FeCl₃, and the silica salt is SiCl₄.

3. The method for preparing an oxidizing agent for a chemical mechanical polishing slurry composition of claim 1, wherein the concentration of the iron salt in the aqueous iron salt solution is 0.1 to 99.0 mol %.

4. The method for preparing an oxidizing agent for a chemical mechanical polishing slurry composition of claim 1, wherein the amount of Si contained in the silica salt is 2 to 10 times of the amount of Fe contained in the iron salt by the mole ratio.

5. The method for preparing an oxidizing agent for a chemical mechanical polishing slurry composition of claim 1, further comprising the step of removing anions contained in the hydration reaction solution.

6. The method for preparing an oxidizing agent for a chemical mechanical polishing slurry composition of claim 5, wherein the step of removing anions is carried out by dialyzing the hydration reaction solution with a membrane.

7. An aqueous oxidizing agent solution comprising:
a nano synthesis particle which is a colloidal silica containing iron, wherein the amount of the nano synthesis particle is 0.1 to 20 weight % with respect to the total aqueous oxidizing agent solution; and
water.

8. The aqueous oxidizing agent solution of claim 7, wherein the aqueous oxidizing agent solution is used for preparing a CMP slurry composition for polishing a metal layer selected from the group consisting of a tungsten containing metal layer, titanium containing metal layer, and titanium nitride containing metal layer.
